(19) United States
(12) Patent Application Publication
(10) Pub. No.: US 2012/0248273 A1
(43) Pub. Date: Oct. 4, 2012

(54) MOUNTING SYSTEM WITH ADJUSTABLE HEIGHT AND LOAD CARRYING SURFACE

(76) Inventor: David Singer, Richmond Hill (CA)

(21) Appl. No.: 13/431,172

(22) Filed: Mar. 27, 2012

Related U.S. Application Data
(60) Provisional application No. 61/468,737, filed on Mar. 29, 2011.

(51) Int. Cl. F16M 13/02

(52) U.S. Cl. 248/297.11

(57) ABSTRACT

In a mounting system suitable for mounting equipment to a wall, through a use of a mechanical advantage, a range of loads available to be accommodated by a single spring is expanded.

### CROSS-REFERENCE TO RELATED APPLICATIONS

The present application is a non-provisional application claiming priority to U.S. Provisional Patent Application Ser. No. 61/468,737, filed Mar. 29, 2011, the contents of which are hereby incorporated herein by reference.

### FIELD

The present application relates generally to a mounting system suitable for mounting equipment to a wall and, more specifically, to a mounting system with an adjustable height and load carrying surface.

### BACKGROUND

Various mounting systems exist for mounting equipment to a wall. Such mounting surfaces are often used in hospitals, where the equipment may be related to the information technology infrastructure of the hospital or may be equipment related to maintaining and/or monitoring the health of a patient.

### BRIEF DESCRIPTION OF THE DRAWINGS

Reference will now be made, by way of example, to the accompanying drawings which show example implementations and in which:

FIG. 1 illustrates a mounting system according to an embodiment of the present disclosure;

FIG. 2 illustrates a simplified representation of the mounting system of FIG. 1;

FIG. 3 illustrates an alternate simplified representation to the simplified representation of FIG. 2; and

FIG. 4 illustrates a further alternate simplified representation to the simplified representation of FIG. 2.

### DETAILED DESCRIPTION

In a mounting system suitable for mounting equipment to a wall, through a use of a mechanical advantage, a range of loads available to be accommodated by a biasing member is expanded. A biasing member can be defined as any object or system which applies a force which acts, directly or indirectly, on the load carrying surface in order to urge the load carrying surface in a direction opposite to the direction the load carrying surface would move under a current set of external forces.

According to an aspect of the present disclosure, there is provided a mounting system. The mounting system includes a load carrying surface, an upper pulley, a lower pulley, a cable attached to the load carrying surface, passing over the upper pulley, under the lower pulley and terminating at a cable anchor and a biasing member biasing the lower pulley downward.

Other aspects and features of the present disclosure will become apparent to those of ordinary skill in the art upon review of the following description of specific implementations of the disclosure in conjunction with the accompanying figures.

When designing mounting systems in the past, designers have attempted to address the problem of accommodating a variety of potential loads. In one approach, a system includes a single spring. The single spring may be selected as the appropriate spring from among a variety of gas or mechanical springs rated for different load ranges. Unfortunately, such a system requires maintenance of multiple springs in stock. While such a single spring system can be pre-configured to work with a given customer's load at the time of sale, the system may be considered to have a small load range. The load range of the selected spring acts to limit the ability of such a mounting system to accommodate different loads in the future. Furthermore, it may be considered difficult to change the single spring in the field. Such a spring change may be necessary if the customer switches to a load outside the range of the originally selected spring.

In another approach, an angled force mechanism may be used to counteract the gravitational force on the load. To accommodate different loads, the angle at which the force acts on the load may be altered around a pivot, thereby adjusting a vertical component of the counteracting force. Unfortunately, such an approach requires a large range of available angles to provide a noticeable change in counteracting force. It can be shown that a change of 36 degrees translates to a 20% force reduction. This greatly increases the area taken up by such a mounting system. Additionally, moving the system changes the selected angle, which causes changes in the counteracting force.

In a further approach, internal friction may be increased in a mounting system that uses a spring or other force mechanism. Such an increase in internal friction may be seen to increase a range of loads available to be accommodated by a given force mechanism. However, friction is a non-conservative force and, when paired with conservative forces, will work with such conservative forces in one direction and against such conservative forces in the opposite direction. The result is that increasing friction will prevent the system from drifting but severely hinder movement in one direction.

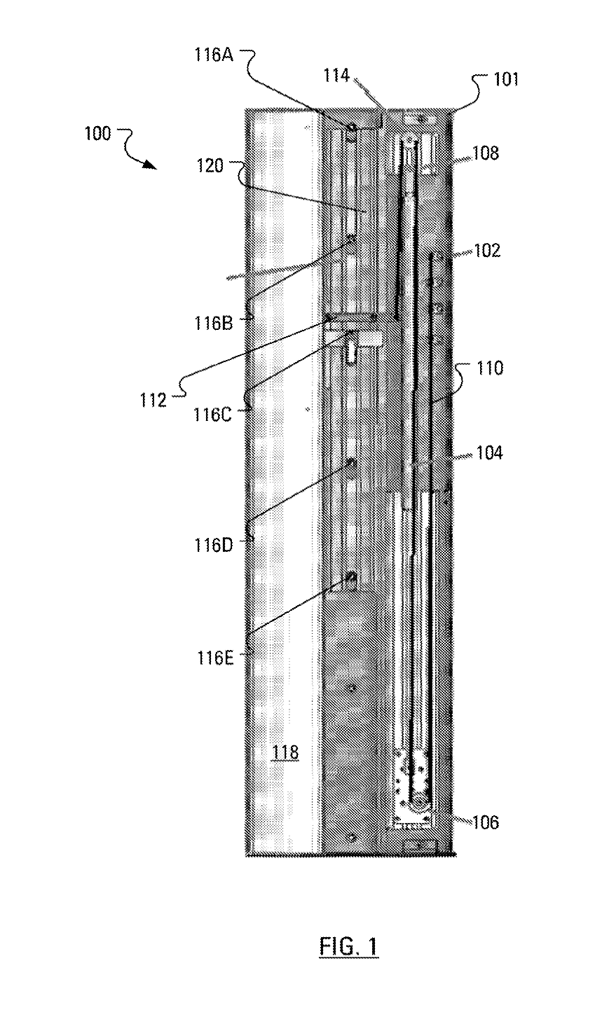

FIG. 1 illustrates a mounting system 100 arranged on a base 101. The mounting system 100 includes a counter-balancing system. The counter-balancing system includes a cable 110 fixed, at one end, to a load carrying surface 112 and, at the other end, to a cable anchor 102. Between the load carrying surface 112 and the cable anchor 102, the cable 110 passed around an upper (fixed) pulley 114 and a lower (non-fixed) pulley 106. An axle (not shown) around which the lower pulley 106 is configured to rotate is maintained within a slot (not shown) formed on the base 101. The slot allows a limited degree of motion along the slot.

A portion of the load carrying surface 112 is arranged to be received by and maintained in a track formed by a rail 120 mounted to the base 101.

The counter-balancing system also includes a spring 104 fixed to the base 101, at an upper end, to a spring anchor 108 and, at a lower end, to the lower pulley 106. The spring 104 is configured to bias the axle of the lower pulley 106 toward the bottom end of the slot. The spring 104 may be considered to be an example of an element that may, more generically, be referred to as a biasing member. A spring is defined here as any system which obeys Hooke's Law throughout its elastic range. A biasing member may be a system following Hooke's Law. Hooke's law is valid for the system throughout the elastic range of the system (i.e., for stresses below the yield strength of the system).

The mounting system 100 may include a locking mechanism for the load carrying surface 112. For example, the base 101 is illustrated in FIG. 1 as including a set of recesses 116A, 116B, 116C, 116D, 116E that may be shaped and sized to receive a sliding bolt (not shown) from the load carrying surface 112.

In alternative locking mechanism for the load carrying surface 112, friction may be used to maintain the load carrying surface 112 in a selected place. For example, a screw (not shown) mounted to the load carrying surface 112 may be used to adjust a force of friction between the rail 120 and a surface associated with the screw. Furthermore, the surface associated with the screw may include additional materials, such as silicone or rubber to enhance the application of the friction.

The equipment mounted on the load carrying surface 112 may include equipment that requires cabling for power, data, gases or liquids. Conveniently, the mounting system 100 illustrated in FIG. 1 includes a cable management compartment 118 defining a recess between itself and the base 101 in which recess such cabling may be hidden from view.

In overview, the mounting system 100 of FIG. 1 implements an adjustable, counter-balancing system to handle variable loads through use of an adjustable counteracting force.

In operation, a load (not shown) is carried by the load carrying surface 112. In neutral equilibrium, the force of gravity that the load applies to the load carrying surface 112 is balanced by a spring force of nX at the spring 104 biasing the axle of the lower pulley 106 downward. The value of “n” is dependent upon the mechanical advantage generated by the pulleys 106, 114 in the counter-balancing system.

When an external force is applied to the load carrying surface 112 carrying a load, the mounting system 100 will deform and the load will move in the direction of the external force at a rate of Y m/s, the spring 104 will also contract or expand at a rate of Y/n m/s, the increase or decrease in biasing force provided by the spring 104 may be shown to change negligibly compared to the external force applied and the load carrying surface 112 will continue to move until load carrying surface 112 reaches the end of the track (defined by the rail 120) or the external force is removed. The change in spring force may be shown to be negligible because the translation of the lower pulley 106 is less than the translation of the mounting surface 112, due to the mechanical advantage generated by the counter-balancing system 114. This phenomenon allows the friction of the system to overcome the change in force of the biasing member 104 throughout the translation of the lower pulley 106 to keep the system at neutral equilibrium. Upon removal of the external force, the mounting system 100 will return to equilibrium such that the load carrying surface 112 stays in a single position.

The spring force, i.e., the extent to which the spring 104 biases the lower pulley downward, may be adjusted beyond the negligible range by adjusting the position of the cable anchor 102. Raising the cable anchor 102 raises the lower pulley 106 and causes the spring 104 to contract without moving the load carrying surface 112. According to Hooke's law, the spring force will increase proportionally to the length of contraction. Depending on the position of the cable anchor 102, the system can accommodate different loads, by using a different functional range of the biasing member 104.

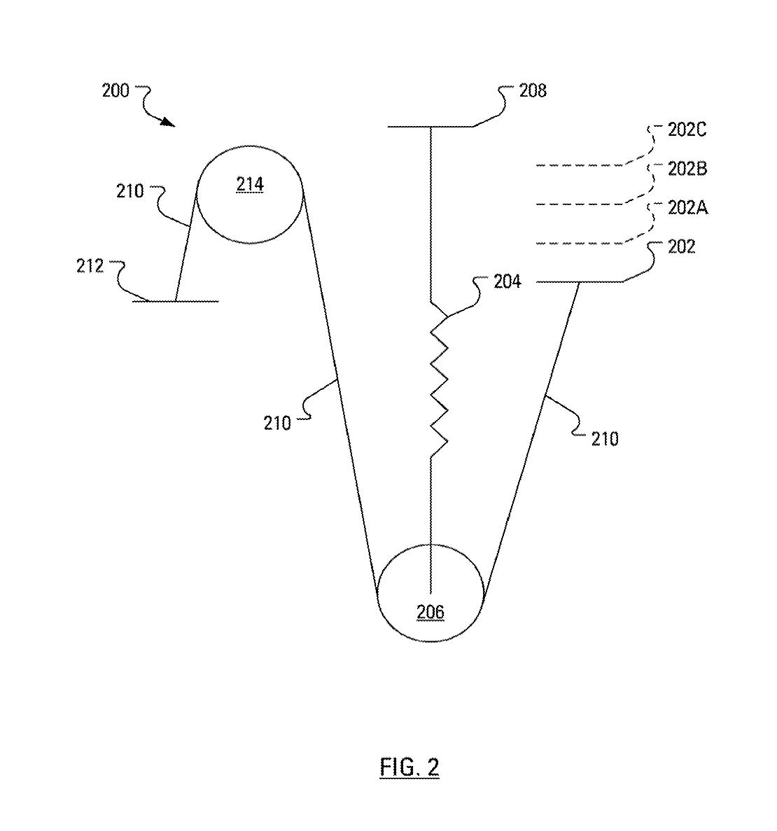

FIG. 2 illustrates a simplified representation 200 of the mounting system 100 of FIG. 1. A cable anchor 202 in FIG. 2 corresponds to the cable anchor 102 in FIG. 1. A spring 204 in FIG. 2 corresponds to the spring 104 in FIG. 1. A lower pulley 206 in FIG. 2 corresponds to the lower pulley 106 in FIG. 1. A spring anchor 208 in FIG. 2 corresponds to the spring anchor 108 in FIG. 1. A cable 210 in FIG. 2 corresponds to the cable 110 in FIG. 1. A load carrying surface 212 in FIG. 2 corresponds to the load carrying surface 112 in FIG. 1. An upper pulley 214 in FIG. 2 corresponds to the upper pulley 114 in FIG. 1. Alternative positions 202A, 202B, 202C for the cable anchor 202 are illustrated with dashed lines.

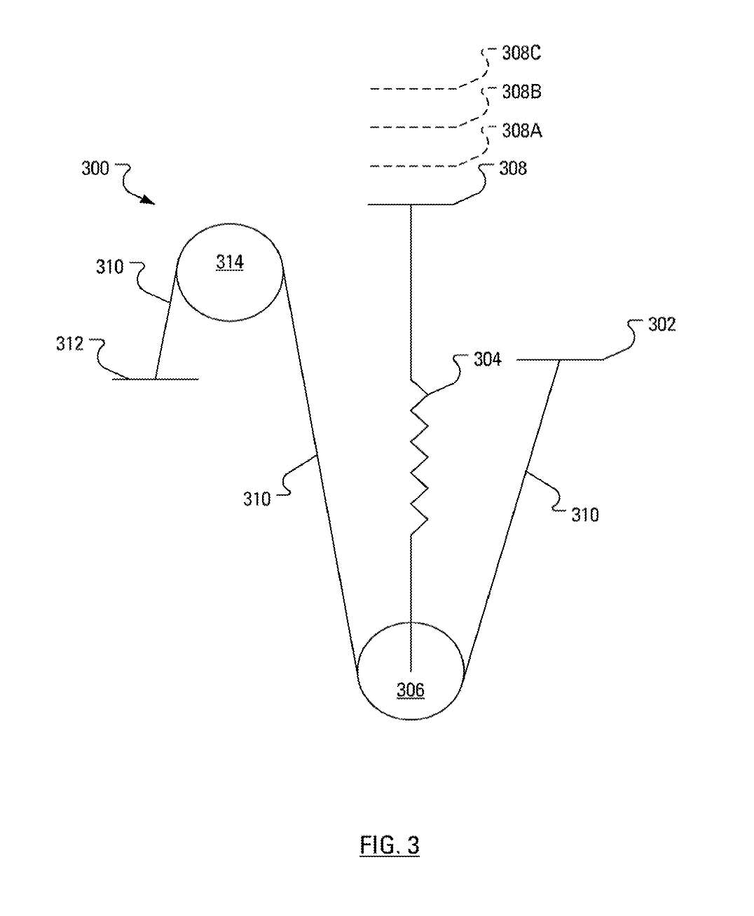

FIG. 3 illustrates an alternate simplified representation 300 to the simplified representation 200 of FIG. 2. A cable anchor 302 in FIG. 3 corresponds to the cable anchor 102 in FIG. 1. A spring 304 in FIG. 3 corresponds to the spring 104 in FIG. 1. A lower pulley 306 in FIG. 3 corresponds to the lower pulley 106 in FIG. 1. A spring anchor 308 in FIG. 3 corresponds to the spring anchor 108 in FIG. 1. A cable 310 in FIG. 3 corresponds to the cable 110 in FIG. 1. A load carrying surface 312 in FIG. 3 corresponds to the load carrying surface 112 in FIG. 1. An upper pulley 314 in FIG. 3 corresponds to the upper pulley 114 in FIG. 1. Alternative positions 308A, 308B, 308C for the spring anchor 308 are illustrated with dashed lines.

The mounting system 100 of FIG. 1, represented in the simplified representation 200 of FIG. 2, the spring anchor 208 is fixed and the cable anchor 202 can be adjusted to be in one of several different positions 202A, 202B 202C.

In contrast, in the alternate simplified representation 300 of FIG. 3, it is the cable anchor 302 that is fixed and it is the spring anchor 308 that can be adjusted to be in one of several different positions 308A, 308B, 308C.

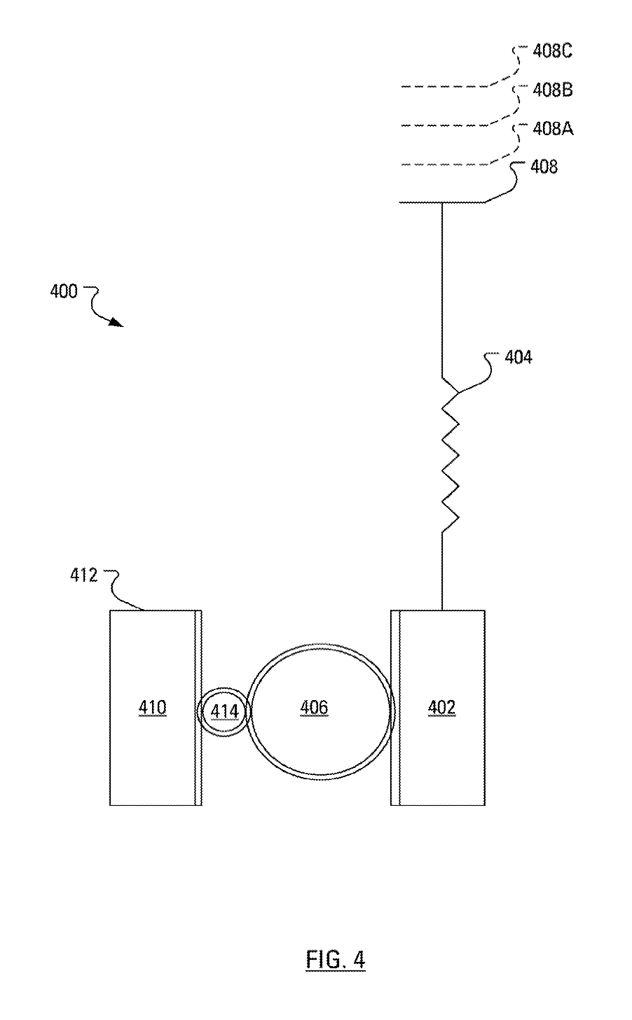

FIG. 4 illustrates a further alternate simplified representation 400 to the simplified representation 200 of FIG. 2. A spring 404 in FIG. 4 corresponds to the spring 104 in FIG. 1. An adjustable spring anchor 408 in FIG. 4 corresponds to the spring anchor 308 in FIG. 3. The lower pulley 106 and the upper pulley 114 are replaced, in FIG. 4, by a first pinion 406 and a second pinion 414. While meshing with the second pinion 414, the first pinion 406 also meshes with a first rack 402. Similarly, while meshing with the first pinion 406, the second pinion 414 also meshes with a second rack 410. A load carrying surface 412, on the second rack 410 of FIG. 4, corresponds to the load carrying surface 112 in FIG. 1. Alternative positions 408A, 408B, 408C for the spring anchor 408 are illustrated with dashed lines.

In operation, a load (not shown) is carried by the load carrying surface 412. In neutral equilibrium, the force of gravity that the load applies to the load carrying surface 412 is balanced by a spring force of nX at the spring 404 biasing the first rack 402 upward. The value of “n” is dependent upon the mechanical advantage generated by the pinions 406, 414 in the counter-balancing system.

When an external force is applied to the load carrying surface 412 carrying a load, the mounting system 400 will deform and the load will move in the direction of the external force at a rate of Y m/s, the spring 404 will also contract or expand at a rate of Y/n m/s, the increase or decrease in biasing force provided by the spring 404 may be shown to change negligibly compared to the external force applied.

The external force applied to the load carrying surface 412 carrying would tend to turn the second pinion 414 at a certain angular velocity, which would tend to turn the first pinion 406 in the at the same angular velocity; the velocity of rack 402 will therefore be much slower than the velocity of rack 410, by a factor established by the gear ratio between the second pinion 414 and the first pinion 406.

The change in spring force may be shown to be negligible because the translation of the first rack 402 is less than the translation of the mounting surface 412, due to the mechanical advantage provided by the pinions 406, 414. This phenomenon allows the friction of the system to overcome the change in force of the biasing member 404 throughout the translation of the first rack 402 to keep the system at neutral equilibrium. Upon removal of the external force, the mounting system 400 will return to equilibrium such that the load carrying surface 412 stays in a single position.

Physically, the mounting systems 100, 200, 300, 400, of the present application have advantages over the previously mentioned approaches in that each mounting system uses only one spring (or, more generically, biasing member) instead multiple springs and in that each mounting system uses a linear mechanical advantage (e.g., a pulley system or a gearing system) to accommodate a wide range of loads. By using a linear mechanical advantage, a more compact system is available when compared to an angling system. Furthermore, the range of adjustability is consistent in both directions, in contrast to a system in which internal friction is changed to extend range. Furthermore, the translation range of the mounting system is increased by (n-1) times the stroke length of the actuating mechanism, where n is the mechanical advantage provided by the system, compared to previously mentioned approaches.

Functionally, the mounting systems 100, 200, 300, 400, of the present application have advantages over the previously mentioned approaches in that none of the mounting systems require spring changes; instead, simple adjustments suffice. Additionally, movement is not hindered by angle limitations and the adjustment system does not hinder movement in one direction.

Conveniently, the mounting systems 100, 200, 300, 400, of the present application allow for mounting of a wide range of loads onto the load carrying surface 112. Furthermore, the mounting systems 100, 200, 300, 400, of the present application allow for translation of the load carrying surface 112. Additionally, the mounting systems 100, 200, 300, 400, of the present application allow for translation of the load carrying surface 112 to be counter-balanced for ease of movement and avoidance of drift for all applicable loads. Even further, the mounting systems 100, 200, 300, 400, of the present application use a non-motorized force mechanism. Further still, the mounting systems 100, 200, 300, 400, of the present application may include a locking mechanism that can be engaged/disengaged to control positioning of the mounting surface, and can include a cable management compartment 118 allowing all cables to be routed from the load carrying surface 112 to various outputs and allows the cables to translate with the load carrying surface 112 when external forces are applied. Furthermore, the mounting systems 100, 200, 300, 400, of the present application may include a secondary writing surface which may fold up in tandem with the primary keyboard surface; act as a writing surface when folded down; and act as a whiteboard surface when folded up.

As will be clear to a person of ordinary skill in the art, the present application is not intended to be limited to an implementation that uses only two pulleys as illustrated in FIGS. 1, 2 and 3. Indeed, increasing numbers of pulleys provide an increasing mechanical advantage and a mounting system can be designed according to the principles laid out herein with more than two pulleys. Similarly, more than two spur gears (pinions 406, 414) may be used in the system of FIG. 4 to customize the mechanical advantage provided thereby. Additionally, the gear ratio between the first pinion 414 and the second pinion 406 can be customized to constraints in a particular system.

The above-described implementations of the present application are intended to be examples only. Alterations, modifications and variations may be effected to the particular implementations by those skilled in the art without departing from the scope of the application, which is defined by the claims appended hereto.

What is claimed is:

1. A mounting system comprising:
a base;
a load carrying surface fixed to said base in a manner that allows linear translation;
an upper pulley mounted to said base;
a lower pulley mounted to said base;
a cable attached to said load carrying surface, passing over said upper pulley, under said lower pulley and terminating at a cable anchor;
a biasing member biasing upper and lower pulleys away from each other, wherein a force provided by said biasing member is adjustable in a manner that is independent of a position of said load carrying surface.

2. The mounting system of claim 1 wherein said biasing member comprises a mechanical spring.

3. The mounting system of claim 1 wherein said biasing member comprises a gas spring.

4. The mounting system of claim 1 wherein said lower pulley is carried upon an axle and said axle is maintained in a slot.

5. The mounting system of claim 4 wherein said biasing member extends between a biasing member anchor and said axle.

6. The mounting system of claim 5 wherein a position of said biasing member anchor is adjustable.

7. The mounting system of claim 1 wherein said a position of said cable anchor is adjustable.

8. The mounting system of claim 1 wherein said biasing member can translate the load carrying surface ‘n’ times its total travel length.

9. The mounting system of claim 1 comprises of a lock to stop translation of the load carrying surface.

10. The mounting system of claim 1 wherein the load carrying surface accommodates various adapters through a rail system.

11. The mounting system of claim 1 comprises of a compartment for cables.

12. The mounting system of claim 1 wherein the load carrying surface accommodates cables into the compartment for cables.

13. The mounting system of claim 1 wherein the load carrying surface accommodates a secondary writing surface.

14. A mounting system comprising:
a base;
a first rack having first rack gears;
a first pinion having first pinion gears arranged to mesh with said first rack gears;
a biasing member fixed, at one end, to said base and fixed, at another end, to said first rack, said biasing member biasing said first rack toward said one end of said biasing member;
a load carrying surface fixed to said base in a manner that allows linear translation;
a second rack associated with said load carrying surface, said second rack having second rack gears; and
a second pinion having second pinion gears arranged to mesh with said second rack gears and said first pinion gears;
wherein a force provided by said biasing member is adjustable in a manner that is independent of a position of said load carrying surface.
